(19) United States
(12) Patent Application Publication
(10) Pub. No.: US 2026/0132284 A1
(43) Pub. Date: May 14, 2026

(54) AGRICULTURAL-WASTE-BASED COMPOSITE ARTICLES AND RESIN SYSTEMS FOR THEIR FABRICATION

(71) Applicant: Equilisyn LLC, Berkeley, CA (US)

(72) Inventors: Robert FLEMING, Berkeley, CA (US); Ethan ESCOWITZ, Berkeley, CA (US)

(21) Appl. No.: 19/387,245

(22) Filed: Nov. 12, 2025

Related U.S. Application Data
(60) Provisional application No. 63/719,569, filed on Nov. 12, 2024.

(51) Int. Cl. C08L 33/04; B29C 70/86; B29K 33/04; B29K 105/00; B29K 105/08; B29K 105/16; B29K 105/24; B29K 105/26; B29K 309/08; B29K 509/00

(52) U.S. Cl. CPC C08L 33/04; B29C 70/86; B29K 2033/04; B29K 2105/0047; B29K 2105/0872; B29K 2105/16; B29K 2105/24; B29K 2105/26; B29K 2309/08; B29K 2509/00; C08L 2205/16; C08L 2207/20; C08L 2312/00

(57) ABSTRACT

A bio-based molded article is formed from a composition that includes a cross-linkable resin and agriculture (agro) waste in the form of at least one of particles and fibers.

### FIELD OF THE INVENTION

The present invention relates to composite materials.

### BACKGROUND

Fiber-reinforced composite materials (“composites”) are a class of materials that offer advantageous properties to products, such as high strength-to-weight ratio, anisotropic properties such as stiffness in one direction and flexibility in another, corrosion resistance, chemical resistance, toughness, and unique geometries and surface aesthetics. Composites are composed, primarily, of fiber and a resin matrix. The fiber provides stiffness and strength, and the matrix serves to hold the fibers in place and transfer stress between the fibers. The matrix additionally protects the fibers, such as from mechanical and environmental damage, and provides corrosion resistance.

The fibers are usually synthetic fibers, polymer fibers, carbon fibers, glass fibers, or ceramic fibers. The fibers are typically in the form of a filament, roving, woven fabric, non-woven fabric, or chopped into short lengths typically between 0.5 and 50 millimeters (mm).

The most common fibers used to reinforce resins are glass fibers and carbon fibers. These fibers work extremely well at reinforcing the matrix (i.e., the solidified resin of the composite), but they are expensive and have a high carbon footprint due to the high temperatures required to make them and the extraction and purification of the precursor materials. Despite these disadvantages, glass and carbon-fiber reinforced composites are widely used in many commercial applications. In contrast, natural fibers have found substantially less application in composites manufacturing due to their high moisture absorption, poor wetting, and poor adhesion to the resin matrix. An additional disadvantage of natural fibers is their limited thermal stability, which limits the maximum processing temperature as well as the resin systems that can be used.

The resins used to bind the fibers are typically thermoplastics or thermosets. Advantageously, thermoplastic resins can be remelted/reshaped multiple times.

Disadvantageously, the molding of thermoplastics requires expensive equipment due to the high processing temperatures and pressures involved. Thermosets are reactive systems that typically start from monomers or pre-polymers, and require relatively lower processing temperatures. Thermosets react and cure into a 3-dimentional molecular network that is no longer melt (re) processable. Some of the most commonly used thermosets are vinyl esters or bisphenol A epoxies. Both of these resins have significant health concerns. Bisphenol A epoxy contains BPA, a known endocrine disruptor, and vinyl ester resins contain styrene; an anticipated human carcinogen.

### SUMMARY

The invention provides compositions and methods for forming molded articles, and molded articles formed therefrom. In accordance with an illustrative embodiment, an agriculture (agro) waste is combined with a resin system, placed in a mold, and then cured to provide a bio-based molded article. Some embodiments of the invention thus convert agricultural waste into a high-value, molded article.

Agro waste is any unwanted or unsalable material produced by agricultural operations. This includes waste from the cultivation and processing of crops, fruits, vegetables, dairy, grains, meat, and poultry. Agricultural waste can be categorized as: (i) crop waste (e.g., rice husk, wheat straws, etc.), (ii) animal waste, (iii) processing waste (e.g., packaging material, fertilizer containers, etc.), and (iv) hazardous waste (e.g., pesticides, insecticides, etc.).

The inventors discovered that the first category of agro waste—crop waste—can be combined with thermoset and/or bio-based resins to create durable products with unique and aesthetically desirable qualities.

Many of the natural fibers in crop waste are very stiff, thereby enhancing the mechanical properties of a resin matrix. And since agro waste is considered to be unwanted/unsalable as noted above, it is very inexpensive. Its use therefore reduces the overall costs of molded parts in comparison to those formed using carbon and glass fibers. Moreover, the bio-based molding constituents used herein include a substantial amount of carbon that is derived from plants. Plants capture carbon dioxide from the air as they grow, and their primary energy source is renewable; that is, the sun. It is therefore highly desirable to incorporate such plant materials into plastic products, and even more so if the plant material is from an existing agricultural waste stream.

For use in conjunction with embodiments of the invention, agro waste is in the form of: (i) natural fibers (continuous fibers and/or chopped fibers) and/or (ii) particles. A “fiber” is typically defined as an individual strand of fibrous material having a length that is much greater than its diameter. In addition to referring to a single strand of material, the term “natural fiber,” as used herein and in the appended claims, can mean one or more “tows” of natural fibers. In a “tow,” multiples of thousands of fibers are grouped together. It is notable that a “tow” generally exhibits the form of a “fiber” (i.e., the length is much greater than the diameter), but the diameter of tow is more typically 0.3 millimeters (mm) or greater, whereas an individual natural fiber may have a diameter ranging from about 10 to 45 microns for animal-based fibers, and from about 50 to 300 microns for plant-based fibers.

A “natural fiber” is fiber that has a natural origin, such as plant-based (cellulose fibers), animal-based (protein fibers), or mineral-based (e.g., asbestos, etc.) the latter being far less common in consumer products. For use herein, plant-based fibers are primarily used.

It is notable that most or all forms of agro waste used in conjunction with embodiments of the invention will be processed to some degree (e.g., run through a grinder and then sorted via two screens). And with some agro waste, such as cotton, hemp, or flax fibers, additional processing may occur, such as harvesting, ginning, cleaning, carding, and combing.

As a general proposition, a “particle” is defined as a fibrous material in which the length of the material is about the same size as the diameter of the material. It is the case, however, that when mechanically chopping natural materials to sizes above about 1 mm, a variety of “shapes” may result that might be characterized as having a form factor other than a “fiber,” but also not necessarily characterized as a “particle.” The resulting shape is a function of cutting method, feeding system, and material properties, including fiber orientation. Examples of such “other than fiber or particle” forms include, without limitation, irregular, curled, or splintered chips, and flakes. As used in this disclosure and the appended claims, every form of agro waste that doesn't meet the definition of fiber (i.e., length much greater than diameter) is considered to be a “particle.”

Some particles begin as one or more fibers; however, after the fibrous-origin material is mechanically processed into usable feedstock, the length and diameter thereof are similar-hence the designation “particle.” By way of example, woodchips are essentially small pieces of wood, and so contain fibers. However, for the reasons discussed above, a wood chip is considered to be a “particle” for the purposes of this disclosure and the appended claims.

In a method in accordance with some embodiments, the agro waste is milled to form particles. Exemplary agro waste for milling includes sawdust from wood processing, nut-shell waste, hemp hurd, fiber from hemp oil processing, or fiber from seed processing. In some embodiments, the resulting particles have a diameter of less than 3 mm. In some of such embodiments, the particles have a diameter of less than 0.3 mm.

In some embodiments, high modulus and high-break-strength natural fibers are selected, cut to a desired length, and used in conjunction with the particles. In some other embodiments, such fibers are used without particles. In some embodiments, the fibers are cut to a length of about 50 mm or less, and preferably in a range of about 3 to 5 mm, irrespective of any feature size of the part (so called “chopped fiber”). In some embodiments, in addition to, or as an alternative to chopped fibers, some fibers are cut to a length that is similar to a feature size of the part (i.e., so called “continuous” fibers), which may be substantially longer than 50 mm.

The particles and fibers may be cleaned with water, alcohol, or solvent, and/or surface treated with an acid, base, or silane coupling agent, and/or dried.

A resin is formulated, which, as discussed further below, includes, in at least some embodiments, a thermoset and/or bio-based resin. At least one type of catalyst for curing resin is added to the resin formulation, forming a “resin system.”

The particles and/or fibers are then added to the resin system, and mixed to yield a uniform dispersion. In some embodiments, natural fabric and/or textile waste is cut to a desired size/shape and added to the mix of particles and/or fiber and the resin system. The mixture is then added to a mold. The material is then cured, and a finished part is ultimately removed from the mold. Some post processing (e.g., trimming, etc.) may be required.

In some embodiments, glass fiber is placed on top of and/or on the bottom of the mixture that is added to the mold, or wrapped around the agro waste before it is added to the resin system.

As to agro-waste-sourced fiber, pineapples, for example, are grown for food, and the pineapple-leaf byproduct can be used as a source of fiber. Similarly for hemp, flax, henequen, kenaf, coir, sisal, banana, abaca, bamboo, bagasse, rice stalks, corn stalks, and nut shells. Agro-waste-sourced particles are milled from less-fibrous forms of the agricultural waste. For example, wood waste in the form of sawdust from the sawmill production of wood boards can be milled into fine particles. Such particles may be used as a filler in the composite. The wood can be chosen for its aesthetic and/or mechanical properties. For example, darker woods such as mahogany or cherry wood can be chosen to impart a darker color to composite, whereas pine, spruce, or aspen can be chosen when a lighter color is desired. In addition, hardwood or softwoods may be selected to impart, to some degree, properties characteristic thereof to the molded article.

A variety of resin formulations are suitable for use in conjunction with embodiments of the invention. One class of suitable resins is thermosets. Suitable thermosets include, for example and without limitation, epoxy, acrylate, vinyl ester, or polyurethanes. Preferably, the resin comprises acrylate monomers, acrylate prepolymers, and urethanes, including urethane prepolymers. Mixtures of acrylates, vinyl esters, and urethanes may also be used. In some embodiments, at least some of the carbon in the resin formulation is sourced from bio-based materials (i.e., a portion of the carbon in some of the monomers and prepolymers is from bio-based sources). In particular, in some embodiments, the bio-based source is corn, wherein precursor molecules from the corn are chemically reacted with acrylic(meth) acid to make an acrylic functional pre-polymer, which can be cross-linked. In some embodiments, the resin formulation includes thermosets and thermoplastics, as well as monomers and prepolymers from bio-based sources. And preferably, the resin does not contain bisphenol A (BPA) or styrene.

There are known disadvantages to the use of natural fibers in composite systems. Such disadvantages include poor fiber-matrix interfacial bonding, poor wettability of the resin to the fiber, and the relatively high level of water absorption and water retention by natural fibers, all of which affects the performance of the resulting composite part.

As to the issue with fiber wetting and interfacial bonding, natural fibers and wood particles are primarily composed of cellulose, hemicellulose, and lignin, the cellulose and hemicellulose being hydrophilic, whereas the resin is hydrophobic, creating an incompatibility. Chemical-surface treatments of natural fibers are often used to address this issue. Furthermore, the moisture absorbed by the natural fibers can interact with metal-containing catalysts that are used to cure thermosets, effectively “poisoning” the catalyst and rendering it ineffective. This often occurs, for example, with vinyl ester resins.

The inventors discovered, unexpectedly, that a UV-curable acrylate resin system (i.e., acrylate resin with UV-activated catalyst) exhibited good curing, wetting, and bonding, even with the natural fibers and natural fillers used in embodiments of the invention. More surprising was the inventors' discovery that when the acrylate-based resin system included both UV-activated catalyst and a thermally-activated catalyst, (and was subjected to both UV and thermal curing operations), even better performance was achieved than with a UV-curable acrylate-based resin system and UV cure alone. In particular, this “dual-catalyst/dual-cure” resin system was characterized by very short cure times, and also excellent resin penetration into the fibers and/or particles, as well as excellent adhesion to the fibers and/or particles. It is believed that the dual-catalyst/dual-cure system exhibited better adhesion to the natural fibers, and a better overall degree of curing. Particularly preferred for such dual systems are organic-peroxide-based thermal catalysts.

In some embodiments, both curing operations are conducted while the materials are in the mold. In some other embodiments, UV curing is conducted while the materials are in the mold, and then the nascent part is then removed from the mold and cured in a separate step. This latter approach results in higher manufacturing efficiency and lower tooling costs.

As to curing, UV light is used for UV-activated catalyst, and IR is preferred for thermal curing, as opposed to other heat sources, since it is faster and more efficient. However, as appropriate, standard convection ovens may suitably be used for thermal curing. As a function of resin/catalyst type, other initiators, such as visible light, microwave radiation, electron beams, etc., may suitably be used, either alone or in combination.

Some embodiments of the invention thus provide a molded, agro-waste-based composite part having excellent stiffness and toughness, and fabricated with a relatively short processing time. The resin formulations used herein are also advantageous in that they can be processed and cured quickly at temperatures significantly lower than 200° C., which is the temperature at which natural fibers may begin to break down. In some embodiments, composite parts are molded and cured at less than 120° C., and in some embodiments, molding and curing occurs at less than 90° C.

As compared to the agro-waste-based particles, the natural fiber has a greater influence on molded-part characteristics such as modulus and toughness. The particles, on the other hand, may be the primary influencer on part characteristics such as hardness and abrasion resistance. Furthermore, the particles are primarily responsible for imparting other important attributes to the composite, such as unique and desirable aesthetics. Additionally, the presence of the particles reduces the amount of volume shrinkage that is associated with curing of the composite part. In some embodiments, parts can be fabricated to be flexible and leather-like. Such flexibility is based on the specifics of the resin formulation.

It is notable that prior-art attempts at combining agro waste in thermoplastics, such as in an extruder, have mostly failed. Among other issues, the temperatures experienced in the extruder (required for combining the resin and agro waste), as well as processing temperatures required for thermoplastics, cause the agro material to substantially degrade. By contrast, embodiments of the invention combine agro waste with substantially lower-viscosity thermosetting monomers, oligomers, and prepolymers. Such materials are also processible at significantly lower temperatures than thermoplastics.

### BRIEF DESCRIPTION OF THE DRAWINGS

FIG. 1 depicts a flow diagram of process in accordance with an illustrative embodiment of the invention.

FIG. 2 depicts a composite sheet formed in accordance with the present teachings.

FIG. 3 depicts a mold for molding temple arms for sunglasses, in accordance with an embodiment of the invention.

FIG. 4 depicts a temple arm formed from the mold of FIG. 3.

FIG. 5 depicts the break stress for several embodiments of a temple arm formed in accordance with the present teachings.

FIG. 6 depicts the elastic modulus for several embodiments of a temple arm formed in accordance with the present teachings.

### DETAILED DESCRIPTION

The following description illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended for pedagogical purposes to aid the reader in understanding the principles of the disclosure and the concepts contributed by the inventors to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

ISO Standard Description for Bio-based ISO 16620:2015 16620:2015 specifies the general principles and the calculation methods for determining the amount of bio-based content in plastic products, using a radiocarbon method.

The following terms are defined for use in this Specification, including the appended claims:
“Fiber” means (a) an individual strand of material, and (b) a plurality of such strands (i.e., a “tow,” which typically includes multiples of thousands of fibers), unless otherwise indicated. A fiber has a length that is much greater than its diameter. In the context of composites, fibers are classified as (i) short/chopped/discontinuous or (ii) continuous. Chopped fibers have a length that is typically much shorter than the part in which they are used, and usually have a random orientation in the final part. Continuous fibers have a length that is comparable to the size of the part in which they are used, or a feature of the part in which they are used (as such, a continuous fiber might actually be a rather “short” fiber). Continuous fibers usually have a defined orientation in the part.
“About” and “Substantially” mean +/−20% of a stated nominal size, quantity, etc.

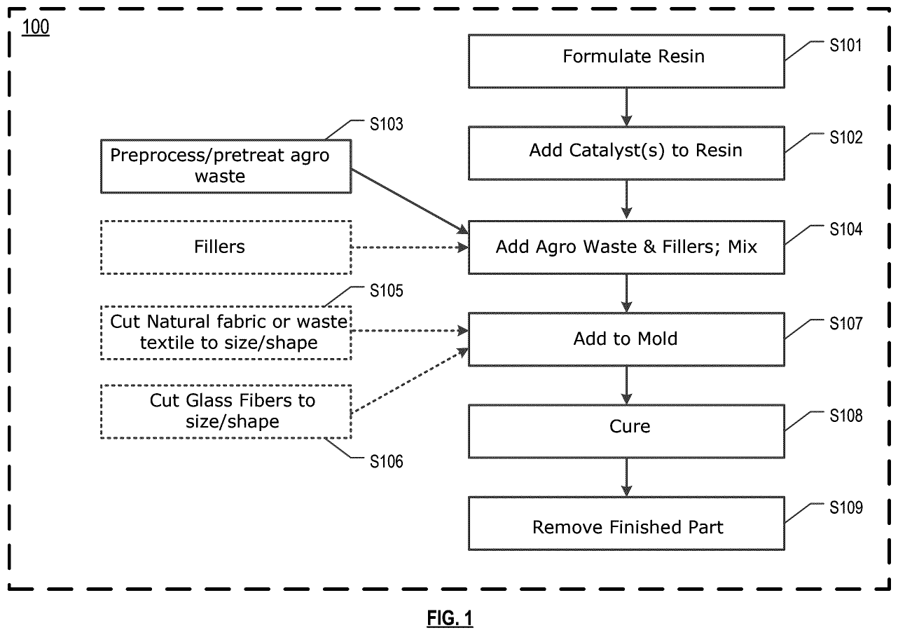

FIG. 1 depicts method 100 for fabricating an agro-waste-based composite part. Method 100 may be used to convert agricultural waste into products such as eye glasses, purses, hats, shoes, boots, backpacks, waist packs, wallets, cell-phone covers, eyeglass cases, book covers, watch bands, raincoats, luggage, sporting-goods equipment, furniture, bookshelves, vehicle parts, automotive interiors, building tiles, airplane interiors, composite panels, etc. It will be appreciated from the description below that many of the operations of method 100 can be performed simultaneously, or in a different order than depicted in FIG. 1.

Of course, before method 100 is performed, a part is designed, and a mold that is suitable for molding the part is fabricated. The part may be designed in a CAD software tool. From the part design, a mold is designed. The mold may be formed from steel, aluminum, glass, plastic, silicone or a combination of these materials. In some embodiments, the mold comprises a low-cost plastic, UV-transparent material, such a PMMA. The material from which the mold is fabricated is machined, 3D printed, cast, or laser cut/etched into shape.

Typically, the mold has a top half and bottom half; these two halves may be made of the same material or different materials. For example, the bottom half of the mold may be machined aluminum, and the top half of the mold may be a transparent material, such as glass or PMMA. In such an embodiment, the resin may be UV-cured through the UV-transparent top half of the mold, and then the top half of the mold is removed. The aluminum bottom half of the mold (with partially cured resin therein) is placed in an oven at a temperature higher than what can be use with PMMA-based molds. Of course, if the part is not UV cured, but rather only thermally cured, then neither half of the mold need be transparent, and a conventional (e.g., steel, aluminum, etc.) mold may suitably be used. Mold materials are selected based on the curing methods used, curing temperature, release from the mold, and mold life (i.e., how many times a mold can be reused), and part quality. In conjunction with this specification, it is within the capabilities of those skilled in the art to design a part, and design and fabricate a mold to make the part, for use in conjunction with embodiments of the invention.

Method 100 includes the operations of:
S101—formulating the resin;
S102—adding catalyst(s) to the resin, forming a resin system;
S103—preprocessing/pretreating the agro waste;
S104—adding agro waste and optional mineral fillers to resin system, and mix;
S105—optionally cutting natural fabric or waste textile to size and shape;
S106—optionally cutting continuous glass fiber to size and shape;
S107—adding the mix formed in operation S104 to mold cavity, and optionally adding natural fabric, and/or waste textile, and/or glass fiber to mold cavity;
S108—cure resin; and
S109—removed finished part from mold cavity.

Operation S101: formulating the resin. In accordance with an illustrative embodiment, the resin formulation includes at least one of a cross-linkable: monomer, oligomer, or prepolymer.

In some embodiments, at least some of the carbon within a resin formulation is sourced from bio-based materials. Examples include: sugars derived from plant sources, oils derived from plant sources, algal oils from marine algae, seaweed, nutshell extracts, soy-based proteins zein protein from corn, polysaccharides such as starch, polyhydroxyalkanoates (PHA's) from food waste, methane waste, or CO₂, polyols from plant sources or from CO₂, diols and polyesters from biomass, and acrylic acid or lactic acid-based polymers from plant sources. Resins can also be made from depolymerized waste plastic made by various depolymerization processes such as chemical, thermal, enzymatic, or bacterial.

In some embodiments, the resin includes non-bio-based monomers, and/or oligomers, and/or prepolymers, as an alternative to, or in addition to, those sourced from bio-based sources. Examples include acrylates, epoxies, urethanes, silanes, silicones, unsaturated polyesters, and/or vinyl compounds. In some embodiments, the thermoset resin is combined with a thermoplastic resin, such as a polyamide, polyester, polylactic acid (PLA), polyacrylate, or polyurethane.

Suitable UV-curable resins, include, without limitation, a broad range of UV-curable acrylates and methacrylates. Exemplary of such UV-curable resins are urethane (meth)acrylates, such as CN975, CN3211, CN1964, CN9024, CN966J75; epoxy acrylate resins, such as CN120, CN2602, or SR349; polyester acrylates, such as CN2102E, CN973J5; and aliphatic multifunctional acrylates, such as SR351, SR9020, SR238, SR399, SR494, SR833s. These resins are commercially available from Arkema Sartomer, having a facility in West Chester, PA. UV-curable resins suitable for use in conjunction with the present invention also include resins commercially available from Allnex (US headquarters Alpharetta, GA) under the tradename Ebecryl®), including polyester-based acrylates such as Ebercryl®) 876, 853, 892, 109, 110, 113 and 114, and urethane acrylates such as Ebercryl®) 1258, 1271, 1290, 1291, and 876. Additionally, suitable UV-curable resins include those available from IGM Resins (US headquarters Charlotte, NC) under the tradename Photomer®, including urethane acrylate resins such as Photomer® 6008, 6010, 6024, 6578, as well as polyester acrylates, epoxy acrylates resins. And UV-curable resins are available from BASF under the Laromer® tradename, including acrylate monomers and resins.

Unsaturated polyester or vinyl ester resins may suitably be used, such as Arkema Sartomer's CN154, which is a vinylester methacrylate resin. Vinyl ester resins can be of the epoxy vinyl ester type, orthphthalic polyester type, or vinylpolyester type for example, commercially available from suppliers such as AOCResins of Collierville, TX, the INEOS Group headquartered in London, UK, and others.

As previously noted, it is desirable to move away from petroleum-based chemistries to bio-based chemistries, which will result in products with a lower carbon footprint. Sources of bio-based chemistries include, for example, oils from plant, animal, seaweed, or algae sources.

Natural oils contain triglycerides based on glycerol and fatty acid chains that contain a degree of unsaturation (i.e., double bonds). These triglycerides can be used in resin formulations or chemically modified, such as by oxidation to alcohols or epoxides, to facilitate alternative reactions. The triglycerides can be broken down into glycerol and fatty acids to be further chemically modified. For example, glycerol can be reacted with acrylic acid to make a substantially bio-based acrylate monomer. The fatty acids can be chemically modified and reacted with other alcohols to make other bio-based monomers that can be later used in resins. Other bio-based organic diacids and diols can be produced from fermentation of sugars by yeast or bacteria.

Starch from plants can also be chemically modified into other useful building blocks; for example, starch can be broken down into glucose and used, or broken down further into sorbitol and then formed into isosorbide. Isosorbide is a diol that can be used as a bio-based building block to make polyesters, polyurethanes, acrylics, epoxies, or polycarbonates.

Some of the disadvantages of triglyceride-based monomers is that the resulting polymers have a lower glass transition temperature, because the fatty acid chain softens the matrix. Moreover, because triglycerides are multi-functional, they can also be relatively brittle. Bisphenol A based polymers usually have excellent hardness, toughness, and chemical resistance. It has been proposed that isosorbide could be a bio-based and safer alternative to bisphenol A. In some embodiments, isosorbide functionalized with epoxy, acrylate, vinyl groups, or isocyanate groups is formulated into a bio-based resin for use herein.

Bio-based UV-curable resins suitable for use in conjunction with embodiments of the invention include, for example and without limitation, resins available from Arkema Sartomer under the tradename Sarbio®, such as resins Sarbio® 7205, 7107, 7106, 6102, 6101, 6100, 5106, 5102, 5201, 5103, and 5100. Allnex also supplies a line of biobased resins suitable for use in conjunction with embodiments of the invention, such as Ebecryl®) 5850, 5849, 5848, 767, 242, 4491, 4683, R1872, and isobornyl (meth)acrylate (IBOA). And IGM Resins includes bio-based resins suitable for use herein under the tradename PureOmer™, such as PureOmer™ 5433, 5437, 5443, 5450, 5662, 5850. Unsaturated polyester resin containing biobased materials is commercially available from INEOS, and others.

Some resin formulations for agro-waste based articles in accordance with the present teaching do not include any bio-based materials. However, it is preferable that resin formulation includes at least about 5 weight percent bio-based material, more preferably at least about 10 weight percent bio-based material, and most preferably at least about 20 weight percent of bio-based material.

Operation S102: adding catalyst to the resin. In this operation, photo-initiator is added to the resin formulation, forming a “resin system.” The photo-initiator is a catalyst that initiates polymerization of the resin. In some embodiments, the photo-initiator is UV activated. Suitable UV photo-initiators include, for example and without limitation, those available under the Speedcure tradename (Arkema Sartomer), including Speedcure BPO, EMK, TPO, TPO-L. BASF also supplies photoinitiators under the Irgacure® tradename, such as Irgacure® 184, 819, and 907. Additionally, photo-initiators suitable for use in conjunction with embodiments of the invention include those available from IGM Resins under the tradename Omnirad, including Omnirad 184, 1173, 127, 1000, ITX, EMK, MBF, OMBB.

In some embodiments, in addition to, or in place of the photo-initiator, a thermal initiator is employed to initiate curing. Suitable thermal initiators include those available from AkzoNoble (aquired by Nouryon), such as Butanox M-50 (ketone peroxide type), Perkadox GB50L or Perkadox L40, Perkadox AMBN, Perkadox AIBN (diacyl peroxide type), or Trigonox 421 (Peroxyesters). Additionallly, thermal initiators are available from Arkema under the tradename Luperox®, including activated organic peroxides such as Luperox® A98, Luperox® LP, Luperox® A75, and Luperox® 10. And in some embodiments, iron-based accelerators from Nouryon (US Chicago, IL), available under the tradename Nouryact® may suitably be used. These iron-based catalysts are less sensitive to moisture than cobalt-based catalysts, and hence less susceptible to moisture poisoning. Typically, IR or convection ovens are used to activate the thermal initiators.

The initiator(s) (photo, thermal, etc.) will typically represent, collectively, about 1 to about 5 weight percent of the resin system.

Operation S103: preprocessing/pretreating the agro waste. Particles, to the extent present, are prepared from agro waste, such as sawdust from wood processing, nut-shell waste, hemp hurd, fiber from hemp oil processing, fiber from seed processing, or blends thereof. The particles are prepared via milling, such as to create particles having a diameter of less than about 3 mm, and in some embodiments, less than 0.3 mm.

Fibers, to the extent present, are prepared from agro waste, such as pineapple, hemp, flax, henequen, kenaf, coir, nettle, sisal, banana, bamboo, abaca, rice stalks, corn stalks, nut shells, and bagasse, or blends thereof. The fibers are cut to a desired length, typically, although not necessarily, to about 50 mm or less, based on the use case (i.e., they may be longer than 50 mm). Often, the fibers will be in a range of about 3 to 15 mm. The fibers can be used in a bundle form as opposed to a finished yarn form, thus requiring less processing and thereby reducing cost. In some embodiments, the particles and the fibers may be cleaned with water, alcohol, or solvent, and/or surface treated with an acid, base, or silane coupling agent, and/or dried.

In embodiments in which agro waste (particles and/or fibers) is dispersed in resin and then added to a mold (operation S107), the agro waste is typically in the range of about 5% to 25% by weight of the mixture (agro waste plus resin). However, when agro waste is added to the mold first and then the resin is added, the agro waste can be present in a much higher concentration, such as about 40% to about 70% by weight of the mixture.

Operation S104: add agro waste & optional mineral fillers to resin system and mix. Mixing can be performed with a high-shear mixer, low-shear mixer, rotary stator type mixer, roller mill, media mill, propeller-type mixer, or planetary mixer, for example. Optionally, heat can be added during mixing to improve mixing, and vacuum can be utilized to remove bubbles, air, moisture, or low-molecular-weight residuals.

Ground-up waste materials and/or mineral fillers are optionally added, such as to impart flame resistance, enhance modulus, modify color, or reduce cost. Non-limiting examples of suitable mineral fillers for whitening include talc, mica, gypsum, silica, kaolin and other clays, diatomaceous earth, aluminum trihydrate, melamine pyrophosphate, and metal oxides and metal hydroxides (zirconia, iron, magnesium, aluminum, etc.). Hemp hurd and fibers are also know to impart flame resistance. Additionally, dyes or pigments may be used to modify/impart color to the final part.

Operation S105: optionally, natural fabric or waste textile are added directly to the mold cavity in operation S107. The natural fabric/waste textile is cut to size and shape for the part being molded.

Operation S106: optionally, glass fibers are added. Continuous glass fibers, typically either in the form of organized sheets (e.g., bidirectional glass fiber weaves, etc.) or randomized sheets (e.g., non-woven veils, etc.), are placed on the bottom and/or top of the mold (the latter after mixture formed in operation S104 is added to the mold). In some other embodiments, the glass fibers can be wrapped around the agro waste. In such other embodiments, the glass-wrapped agro waste is not added to the resin mixture in operation S104; rather, it is added directly to the mold cavity prior to adding the resin mixture to the mold cavity.

The inclusion of the glass fiber provides several benefits. In particular, by positioning relatively stiffer material (glass fiber) at the surface of a part, away from the axis of bending of the part, the relatively stiffer material is ideally placed to resist the mechanical forces of bending on a part. Moreover, sheets of glass fibers, which are composed of smooth, round, cross-sectional shape glass fibers, may be used to create a layer that separates the potentially rough and hard agro-waste from smooth mold surfaces that are prone to wear, and expensive to repair or replace. Also, glass fiber adds toughness, modulus, higher break stress, scratch resistance, thermal resistance, insulative properties, and other material properties desirable to have at the surface of a part. Additionally, by realizing the aforementioned functions while occupying a very small volume of the part, the glass fiber effectively maximizes the portion of the volume occupied by agro waste, thus elevating the sustainability score of the product. Although in some other embodiments, other textiles may be substituted or combined with glass fiber, such as for aesthetic or functional reasons (such as to provide a brand logo on a fabric), glass fiber is unique in its ability to provide the above-mentioned benefits without hiding the desirable aesthetic character of the underlying natural material and/or agro-waste. In particular, the refractive index of glass is about the same as the refractive index of the resin, such that the light passes through the glass without substantial diffraction, making the glass effectively invisible.

Operation S107: add mixture prepared in operation S104 and any optional materials to the mold cavity. Additional resin may be added at different times and locations throughout the mold-filling step. Various methods can be used to completely impregnate the fibers with resin, such as heating, and/or vacuum. Once the resin, natural fibers, wood particles, and optional textile and optional glass fibers are added to the mold, the mold is closed, degassed, and purged with additional resin as necessary.

Rather than adding the agro waste to the resin per operation S104, the agro waste can be added directly to the mold, then add textiles, fibers, glass, etc., close the mold and then fill the mold with the resin formulation. As previously noted, adding the agro waste to the mold prior to the resin permits much higher levels of agro waste in the mixture. For example, in one embodiment in which agro waste is added to mold prior to exposure to resin, the composition was as follows:

| Component | Wt % |
|---|---|
| Agro Waste | 42.9 |
| Textile (S105) | 14.3 |
| Glass (S106) | 14.3 |
| Resin | 28.5 |

Operation S108: curing. The resin is then cured via an appropriate modality as a function of the resin/initiator in the resin mix; that is, UV, IR, microwave, convection, etc. An optional post-curing operation may be performed. Post curing is typically conducted in an oven, at temperatures in the range of 45° C. to 200° C., depending on the materials used. Preferably the post curing occurs at less than 100C. The part can optionally be removed from the mold prior to post curing. Curing typically lasts about 1 to about 4 hours, depending upon resin type, and the manner of curing, among other factors.

Operation S109: remove the molded part from the mold cavity. Post processing typically occurs, such as trimming flash, sanding, and polishing.

### EXAMPLES

### Example 1: Pineapple Leaf Fiber and Mahogany Composite Sheet

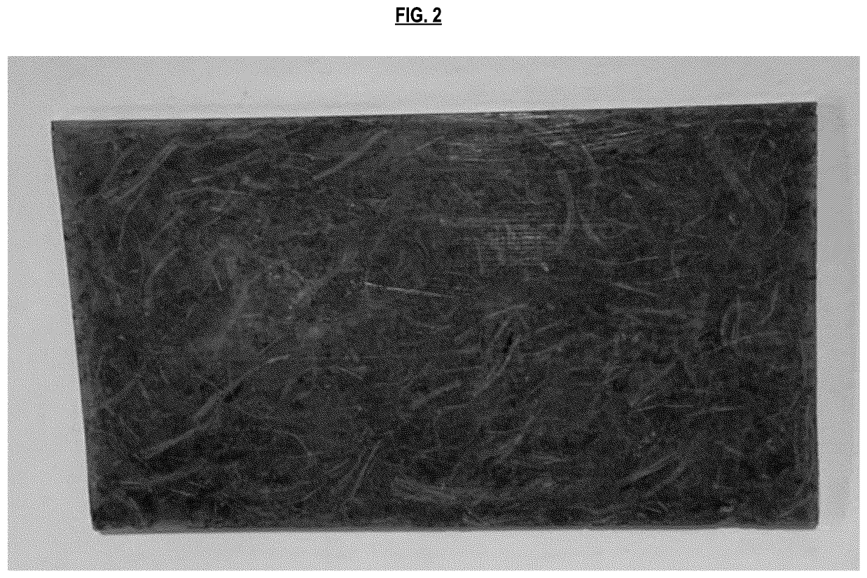

A rigid sheet of mahogany and pineapple leaf fiber was produced as follows.
1. 30 grams of Ebecryl® 5850 (bio-based resin) were added to a jar, then 0.5 gram of Irgacure® 819 (UV-initiator) and 0.5 grams of Luperox® LP (thermal initiator) were added to the jar.
2. The mixture was heated to 40° C. with stirring until the Irgacure® and Luperox® dissolved, then 20 grams of CN966J75 (urethane diacrylate oligomer blended with isobornyl acrylate-Arkema) were added to the mixture and stirred until a transparent solution was obtained.
3. Mahogany sawdust was added to a (different) jar with 10 mm diameter marbles, and rolled for 2 hours until the sawdust was milled to a fine powder.
4. The powder was then vacuum dried at 45° C. and 27 inches Hg.
5. Pineapple leaf roving was cut to lengths of 10 mm and dispersed into isopropyl alcohol with a heavy-shear mixer.
6. The pineapple leaf dispersion was pressed dry with a paper towel, and the pineapple leaf fiber was then vacuum dried at 45° C. and 27 inches Hg.
7. 25.3 grams of the resin mixture from step 1 was added to a clean jar, 1.0 grams of mahogany powder from step 4 was added to the resin mixture, and 1.3 grams of pineapple leaf fiber from step 6 was added to the resin.
8. The mixture from step 7 was mixed with an overhead mixer, then degassed at 27 inches Hg.
9. One side of a sheet of ¼″ polymethylmethacrylate (PMMA) was coated with the mixture from step 8, and then another sheet of ¼″ PMMA was applied with pressure to the coated surface to remove air bubbles.
10. The resin within the PMMA sheets was cured by UV light exposure from an Omnicure Series 2000 light source.
11. The arrangement of PMMA sheets/partially cured resin was then placed into an oven at 77° C. for 2 hours.
12. The mold was removed from the oven and allowed to cool to room temperature.
13. The finished part was removed from the mold and is shown in FIG. 2.

Three-point bending flexural testing was performed on the resulting part, which measured 3.3 mm in thickness, and 12.8 mm in width. Across a span of 36.7 mm, the bending modulus was to determined to be about 1.5 Gpa, and the break stress was measured to be 34.8 Mpa. Qualitatively, the part showed good color and flex.

### Example 2—Temple Arms for Sunglasses

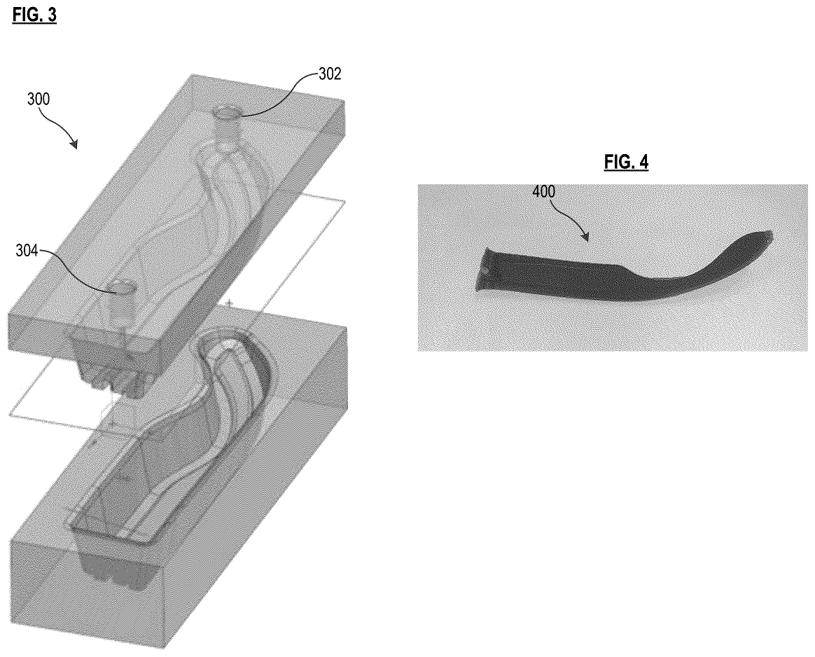

Sunglass temple arms were fabricated as follows.
1. 20 grams of Ebecryl® 5850 were added to a jar, then 0.4 gram of Irgacure® 819, 0.6 grams of Luperox® LP, and 3.0 grams of Sarbio® 5102 solution (Arkema Sartomer bio-based resin) were added to the jar.
2. The mixture was heated to 40° C. with stirring until the Irgacure® and Luperox® dissolved, then 20 grams of CN966J75 (Arkema) were added to the mixture and stirred until a transparent solution was obtained.
3. 4 grams of waste hemp hurd was milled to a fine powder and sieved through a 150-micron screen.
4. The powder was dried for 30 minutes at 75° C. then added to the resin mixture.
5. The mixture obtained from step 4 was added to mold 300 shown in FIG. 3 via a syringe attached to port 302, while 27 inches Hg vacuum was applied a second port 304.
6. Excess resin was purged from the mold with a syringe through one of the ports (e.g., port 304) in mold 300 until all air was removed from the mold.
7. Mold 300 was exposed with UV from the Omnicure 2000 on all sides thereof.
8. Mold 300 was then placed into an oven at 77° C. for 2 hours.
9. Mold 300 was removed from the oven and allowed to cool to room temperature.
10. The finished part—the temple arm—was removed from the mold and is shown in FIG. 4.

The temple arms formed in accordance with Example 2 exhibited satisfactory flex.

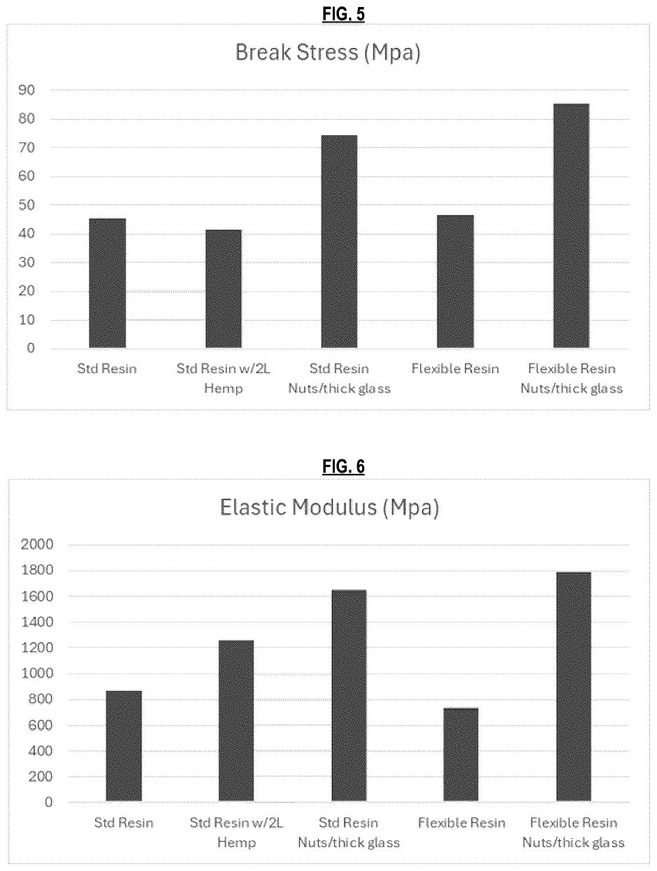

A plurality of temple arms were fabricated. Three temple arms were prepared in accordance with the present teachings, wherein agro waste (hemp or nuts/glass fiber) was used. And two temple arms were prepared using a resin that include some bio-based material, but no agro waste. The break stress of the fiber temple arms is depicted in FIG. 5, and the elastic modulus is depicted in FIG. 6.

Summarizing, embodiments of the invention, as depicted and described, provide: a composition for forming a composite part, a bio-based composite part, and a method for forming a bio-based composite part.

In some embodiments, the composition for forming a composite part includes: (a) a resin formulation, the resin formulation comprising at least one of a cross-linkable: monomer, oligomer, and prepolymer; (b) a catalytically effective amount of at least one initiator suitable for curing the at least one cross-linkable monomer, oligomer, and polymer; and (c) agro waste, in the form of at least one of particles and fibers.

In some embodiments of the composition:
the cross-linkable monomer, and/or oligomer, and/or prepolymer is an acrylic.
the cross-linkable monomer, and/or oligomer, and/or prepolymer includes bio-based material.
the bio-based material is at least about 20 weight percent of the resin formulation.
the resin formulation comprises a thermoplastic.
the agro waste is present in an amount in a range of about 5 to 25 weight percent of the composition.
the agro waste is present in an amount in a range of about 5 to about 80 weight percent of the composition.
the initiator is a photo-initiator or a thermal initiator, or both.
the photo-initiator is a UV initiator and the thermal initiator an activated organic peroxide.
mineral fillers are included.
a material selected from the group consisting of natural fabric, waste textile, and glass fibers is included.

In some embodiments, the bio-based composite part includes: (a) a matrix comprising a cross-linked resin; and (b) agro waste in the form of at least one of particles and fibers dispersed in the matrix.

In some embodiments of the bio-based composite part:
the cross-linked resin comprises carbon sourced from a bio-based material.
mineral fillers are included.
at least one of natural fabric and waste textile is included.
glass fiber is included, wherein the glass fiber is proximate to at least one surface of the composite part.
glass fiber is included, wherein the glass fiber is wrapped around the agro waste.

In some embodiments, the method includes: (a) formulating a resin, the resin comprising at least one of a cross-linkable monomer, oligomer, and polymer; (b) adding at least one initiator to the resin forming a resin system, the initiator for initiating cure of the resin; (c) providing agro waste; (d) adding agro waste and the resin system and to a mold cavity; and (e) curing the resin.

In some embodiments of the method:
the resin comprises carbon sourced from a bio-based material.
the initiator is a photo-initiator, or a thermal initiator, or both.
the initiator is a UV initiator and an activated organic peroxide as a thermal initiator.
providing agro waste comprises milling the agro waste to form particles having a diameter less than 3 millimeters.
providing agro waste comprises milling and screening the agro waste to form particles having a distribution of largest-particle-dimension greater than 0.75 millimeters and less than 3 millimeters.
providing agro waste comprises milling and screening the agro waste to form particles having a distribution of largest-particle-dimension greater than 0.75 millimeters and less than 5 millimeters.
providing agro waste comprises obtaining fibers from the agro waste and cutting the fibers to a desired size.
at least one of natural fabric and waste textile is added to the mold cavity.
a first sheet of glass fiber is added to the mold cavity before adding the agro waste and the resin system thereto.
a second sheet of glass fiber is added to the mold after adding the agro waste and the resin system to the mold.
wherein at least one of the first sheet of glass fiber and the second sheet of glass conforms to at least part of a surface of the mold cavity.
the agro waste is added to the mold cavity before adding the resin system to the mold cavity.
a first sheet of glass fiber is added to the mold cavity before adding the agro waste.
a second sheet of glass fiber is added to the mold cavity after adding the agro waste and before adding the resin system to the mold cavity.
the first sheet of glass fiber conforms to at least part of a surface of the mold cavity.
at least one the first sheet of glass fiber and the second sheet of glass fiber conforms to at least part of a surface of the mold cavity.
a third sheet of glass fiber is added to the mold cavity after adding the resin system to the mold.
curing the resin comprises exposing the resin to UV light, and then heating the resin.

What is claimed:

1. A composition for forming a composite part, the composition comprising:
a resin formulation, the resin formulation comprising at least one of a cross-linkable: monomer, oligomer, and prepolymer;
a catalytically effective amount of at least one initiator suitable for curing the at least one cross-linkable monomer, oligomer, and polymer; and
agro waste, in the form of at least one of particles and fibers.

2. The composition of claim 1 wherein the at least one cross-linkable: monomer, oligomer, and prepolymer is an acrylic.

3. The composition of claim 1 wherein the resin formulation comprises a thermoplastic.

4. The composition of claim 1 wherein the at least one cross-linkable: monomer, oligomer, and prepolymer includes bio-based material.

5. The composition of claim 4 wherein the bio-based material is at least about 20 weight percent of the resin formulation.

6. The composition of claim 1 wherein the agro waste is present in an amount in a range of about 5 to 25 weight percent of the composition.

7. The composition of claim 1 wherein the agro waste is present in an amount in a range of about 5 to about 80 weight percent of the composition.

8. The composition of claim 1 wherein the initiator is a photo-initiator.

9. The composition of claim 1 wherein the initiator is a thermal initiator.

10. The composition of claim 1 the initiator comprises a photo-initiator and a thermal initiator.

11. The composition of claim 10 wherein the photo-initiator is a UV initiator and the thermal initiator an activated organic peroxide.

12. The composition of claim 1 comprising mineral fillers.

13. The composition of claim 1 comprising a material selected from the group consisting of natural fabric, waste textile, and glass fibers.

14. A bio-based composite part comprising:
a matrix, the matrix comprising a cross-linked resin; and
agro waste in the form of at least one of particles and fibers dispersed in the matrix.

15. The composite part of claim 14 wherein the cross-linked resin comprises carbon sourced from a bio-based material.

16. The composite part of claim 14 comprising mineral fillers.

17. The composite part of claim 14 comprising at least one of natural fabric and waste textile.

18. The composite part of claim 14 comprising glass fiber, wherein the glass fiber is proximate to at least one surface of the composite part.

19. The composite part of claim 14 comprising glass fiber, wherein the glass fiber is wrapped around the agro waste.

20. A method comprising:
formulating a resin, the resin comprising at least one of a cross-linkable monomer, oligomer, and polymer;
adding at least one initiator to the resin forming a resin system, the initiator for initiating cure of the resin;
providing agro waste;
adding the agro waste and the resin system and to a mold cavity; and
curing the resin.

21. The method of claim 20 wherein the resin comprises carbon sourced from a bio-based material.

22. The method of claim 20 wherein adding the at least one initiator comprises adding a photo-initiator.

23. The method of claim 20 wherein adding the at least one initiator comprises adding a thermal initiator.

24. The method of claim 20 wherein adding the at least one initiator comprises adding a photo-initiator and a thermal initiator.

25. The method of claim 20 wherein adding the at least one initiator comprises adding a UV initiator and adding an activated organic peroxide as a thermal initiator.

26. The method of claim 20 wherein providing the agro waste comprises milling the agro waste to form particles having a diameter less than 3 millimeters.

27. The method of claim 20 wherein providing the agro waste comprises milling and screening the agro waste to form particles having a distribution of largest-particle-dimension greater than 0.75 millimeters and less than 3 millimeters.

28. The method of claim 20 wherein providing the agro waste comprises milling and screening the agro waste to form particles having a distribution of largest-particle-dimension greater than 0.75 millimeters and less than 5 millimeters

29. The method of claim 20 wherein providing the agro waste comprises obtaining fibers from the agro waste and cutting the fibers to a desired size.

30. The method of claim 20 comprising adding at least one of natural fabric and waste textile to the mold.

31. The method of claim 20 comprising adding a first sheet of glass fiber to the mold cavity before adding the agro waste and the resin system thereto.

32. The method of claim 31 comprising adding a second sheet of glass fiber to the mold after adding the agro waste and the resin system to the mold.

33. The method of claim 31 wherein at least one of the first sheet of glass fiber and the second sheet of glass conforms to at least part of a surface of the mold cavity.

34. The method of claim 20 comprising adding the agro waste to the mold cavity before adding the resin system to the mold cavity.

35. The method of claim 34 comprising adding a first sheet of glass fiber to the mold cavity before adding the agro waste.

36. The method of claim 35 comprising adding a second sheet of glass fiber to the mold cavity after adding the agro waste and before adding the resin system to the mold cavity.

37. The method of claim 35 wherein the first sheet of glass fiber conforms to at least part of a surface of the mold cavity.

38. The method of claim 36 wherein at least one the first sheet of glass fiber and the second sheet of glass fiber conforms to at least part of a surface of the mold cavity.

39. The method of claim 36 comprising adding a third sheet of glass fiber to the mold after adding the resin system to the mold.

40. The method of claim 25 wherein curing the resin comprises exposing the resin to UV light, and then heating the resin.
